(19) United States
(12) Patent Application Publication
(10) Pub. No.: US 2011/0009282 A1
(43) Pub. Date: Jan. 13, 2011

(54) HIGH THROUGHPUT SCREENING METHOD AND APPARATUS FOR ANALYSING INTERACTIONS BETWEEN SURFACES WITH DIFFERENT TOPOGRAPHY AND THE ENVIRONMENT

(76) Inventors: Jan de Boer, Zeist (NL); Clemens Antoni Van Blitterswijk, Ruigahuizen (NL); Hemant Vijaykumar Unadkat, Enschede (NL); Dimitrios Stamatialis, Enschede (NL); Berendien Jacoba Papenburg, Enschede (NL); Matthias Wessling, Enschede (NL)

Correspondence Address: KNOBBE MARTENS OLSON & BEAR LLP, 2040 MAIN STREET, FOURTEENTH FLOOR, IRVINE, CA, 92614, US

(21) Appl. No.: 12/741,019

(22) PCT Filed: Oct. 31, 2008
(86) PCT No.: PCT/NL2008/050686

§ 371 Date: Aug. 16, 2010

(30) Foreign Application Priority Data
Nov. 2, 2007 (EP) 07119929.3

(51) Int. Cl. C40B 30/04; C40B 40/02; C40B 40/06; C40B 40/10

(52) U.S. Cl. 506/9; 506/14; 506/16; 506/18

(57) ABSTRACT

The invention is directed to a high throughput screening method for analyzing and interaction between a surface of a material and an environment. The screening method of the invention comprises: providing a micro-array comprising said material and having a multitude of units at least part of which have different topography; contacting at least part of said multitude of units with said environment; and screening said micro-array for an interaction between one or more of said units and said environment.

The invention is directed to a high throughput screening method for analysing the interaction between material surfaces and their environment, and to an apparatus for performing high throughput screening.

In the past there has been an extensive search for materials that can be used for clinical applications. Important examples of widely used materials in clinical applications are titanium implants, amalgam dental implants and plastic heart valves. A key to the successful use of most materials has been their biological inertness, i.e. minimal interaction of between the material and the surrounding tissue.

In spite of these advantageous properties, it is generally accepted that full restoration of the normal tissue is the ideal remedy. A favourable approach is to implant materials that can temporarily provide mechanical support, but which will eventually degrade to make place for restored normal tissue. An illustrative example is the degradable suture. After wound healing, the suture is no longer required and will degrade. Many degradable polymer systems are available. In specific fields, such as in the field of bone reconstruction, also degradable ceramic materials, as well as polymer/ceramic composites are used.

Degradable implants are further favourable in the field of bone and cartilage surgery. The main surgical treatments in this field rely on the use of metallic medical implants in conjunction with bone or bone substitutes. These implants must be successfully incorporated in the bone tissue in order to obtain good clinical results. Major advances and results have been achieved in this area during the last decades, but implant loosening over time continues to be a significant problem for successful long-term joint replacements. The current materials are not able to achieve bridging of larger bone defects and to maintain long-term stability alone. The use of bone graft taken from the patients themselves to solve these problems is followed by a relatively high donor site morbidity of 15-30 percent. As many as 20% of the patients undergoing hip replacement develop bone loss around the prosthesis within 10 to 15 years of the initial surgery, and in spine fusion surgery 20-30 percent of the patients obtain poor fusion. Furthermore, as the near-future patient population will include a significant number of younger patients, the problem concerning long-term aseptic implant loosening is predicted to increase dramatically.

The biocompatibility/biointegration of an implant in the body is extremely complicated, involving processes traditionally belonging to medical science, surface science, materials science, and molecular biotechnology. Within a few milliseconds after an implant is inserted into the body, a biolayer consisting of water, proteins and other biomolecules from the physiological liquid is formed on the implant surface. Cells from the surrounding tissue migrate to the area around the implant. The properties of the implant surface strongly influence the interaction with the cells. In order to optimise biocompatibility the influence of the implant surface on the cell biological properties is therefore of crucial importance. In addition, the properties of the cells, e.g. their ability to communicate through the extracellular matrix by signal molecules, is important for good biocompatibility. All these mechanisms contribute to the response of the tissue to the implant and determine whether the implant is successfully anchored with sufficient mechanical strength in the bone of the patient or whether an inflammatory reaction against the implant occurs, which finally will result in aseptic loosening and operative failure.

It is generally acknowledged that the interaction between the material of a medical device or implant and its surrounding tissue or cells can be improved by tailoring the surface topography, see e.g. WO-A-2006/114098.

It has been shown that the surface topography can for instance influence the cell orientation, cell adhesion and proliferation, and/or cell differentiation.

Cell orientation can be controlled by patterns manufactured on the biomaterials, such as described for instance for tendon repair (Curtis et al. Eur. Cell Mater. 2005, 9, 50-57) and cardiomyocyte orientation (Deutsch et al. J. Biomed. Mater. Res. B 2000, 53(3), 267-275). Recently, the present inventors also demonstrated the alignment of C2C12 mouse pre-myoblasts and MC3T3 mouse pre-osteoblasts by micro-pattern polymer design (Papenburg et al. Biomaterials 2007, 28(11), 1998-2009).

Adhesion of cells to materials can be a desirable property for instance in the field of bone surgery, because it enhances the contact between the material and adjacent bone tissue. In contrast, it can be undesirable in other applications, such as when artificial aortic valves are implanted. Cell adhesion can be controlled by topological design of the biomaterial surface as extensively described in the literature (see for instance Den Braber et al. J. Biomed. Mater. Res. A 1998, 40(2), 291-300; Van Kooten et al. J. Biomed. Mater. Res. B 1998, 43(1), 1-14; and Thapa et al. J. Biomed. Mater. Res. A 2003, 67(4), 1374-1383). For instance, surface roughness has an effect on the properties of the integrin family of cell surface receptors (Luthen et al. Biomaterials 2005, 26(15), 2423-2440). In addition, the present inventors recently described an effect of polymer fibre diameter and surface topography on human mesenchymal stem cell proliferation (Moroni et al. Biomaterials 2006, 27(28), 4911-4922).

Further, surface topography can influence cell differentiation. Cell patterning on geometrically defined shapes has been widely used to study the effects of cell shape on cell fate decision (Chen et al. Science 1997, 276(5317), 1425-1428). In a classical experiment outlining that cell shape can control stem cell differentiation micro-patterning was used to create patches of adhesive surfaces of different size (McBeath et al. 2004, 6(4), 483-495). Human mesenchymal stem cells (hMSCs) grown on small patches remained rounded and preferentially differentiated into adipocytes, whereas hMSCs grown on large patches spread and differentiated into osteoblasts. In this line of thought, biomaterials which are able to manipulate cell morphology could potentially control cell differentiation. The challenge for the field of biomaterials research lies in defining the proper topography for the desired application.

So far, however, the design of biomaterials in order to manipulate the interaction of medical devices with their surrounding tissue through surface topography has been performed mainly through rational design or trial and error, characterised by low numbers of variations.

Not only biomaterials for use in implants and medical appliances are subject to trial and error design. Also in numerous other applications interactions between the material and its environment plays a major role in the effectiveness and/or suitability of the material. In most cases the topography of the material is an important factor of such interactions, since the material is in contact with its environment through the surface topography.

Object of the invention is to provide a screening method for analysing the interaction between a library of topographies and a specific environment that allows high throughput screening of a vast number of variations.

A further object of the invention is to provide a high throughput screening method for cellular and/or tissue compatibility of materials and surface topographies.

Yet a further object of the invention is to provide a screening method for materials that can be used in the manufacture of medical devices that, during application, come into contact with the human body, such as stents, sutures, pacemakers and the like.

A further object of the invention is to provide a high throughput screening method for analysing the suitability of materials and/or topographies that are used in biomedicine, pharmaceutics, oncology, regenerative medicine, neurology, and domestic tools.

Further object of the invention is to provide a screening method for suitable materials to be used as cartilage and/or bone substitutes.

It was found that one or more of these objects can be met by using a micro-array having a multitude of units at least part of which have different topography.

Accordingly, in a first aspect the invention is directed to a high throughput screening method for analysing an interaction between a surface of a material and an environment comprising:

providing a micro-array comprising said material and having a multitude of units at least part of which have different topography;

contacting at least part of said multitude of units with said environment; and

screening said micro-array for an interaction between one or more of said units and said environment.

The inventors found that in accordance with the invention it is possible to screen a vast amount of different materials and/or different surface topographies for a specific interaction with the environment. The invention allows a quick and efficient screening of potential materials and surface topographies in order to find good candidates. These candidates can be explored in more detail. For instance, this opens huge potential for improving medical devices and implants which during application are in contact with cells, cell cultures, and/or tissue.

Various environments are possible in accordance with the method of the invention. The environment can for instance comprise a tissue, a cell, a complex molecular mixture (such as body fluid, soil, sea water, air, cell lysates, organs or whole organisms, waste products, urine, faeces). However, it is also possible that the environment comprises specific molecules. If the environment comprises a cell, a complex molecular mixture or specific molecules, the invention involves contacting the micro-array with said cell, said complex molecular mixture or said specific molecules, respectively.

By varying the architecture and/or surface properties of the materials advantageously everyday materials (such as biomaterials) can be applied by merely changing the topography. Hence, no involved recombinant proteins or complicated chemistry is required. The strategic design of material topography can improve the interaction with the environment.

In an embodiment, the micro-assay comprises a biocompatible material, such as a biocompatible polymer. The material can be biodegradable. Suitable examples of biodegradable polymers include polyethylene oxide/polybutylene terephthalate copolymers (PEO/PBT), polymers of the polyester family such as poly(lactic acid) (PLA), and poly(glycolic acid) (PGA), and their copolymers, polylactones (such as poly(ε-caprolactone)), polycarbonates (such as trimethylene carbonates), polyanhydrides, polyorthoesters, polyurethanes, and derivatives thereof (Gunatillake et al. Eur. Cell Mater. 2003, 5, 1-16). Also copolymers and/or blends of different polymers can be used in the micro-array of the invention.

Other suitable materials which can be comprised in the micro-assay include ceramics, semiconductors, metals, metal oxides, metal nitrides, alloys, polymer/ceramic composites, carbon, and copolymers and/or blends thereof. If desired, these materials can be combined with suitable polymers.

The micro-array comprises a multitude of topographic units. The amount of the topographic units can vary in a wide range. It is advantageous that the amount of topographic units is large so that a large number of topographic units can be screened for cellular compatibility in one batch. For instance the micro-array can comprise at least 100 topographic units, preferably at least 10 000 topographic units, more preferably at least 30 000 topographic units. The upper limit of the amount of topographic units is for practical reasons about 300 000 topographic units, or 250 000 topographic units, but is not intrinsically limited. This is in contrast to patent WO-A-02/02794. The invention mentioned therein is limited to devices with 96, 384 or 1536 wells. Furthermore it has thermally insulated wells of different geometries. In our invention we have wells which have the same geometries and which can be uniformly varied.

The size of a single topographic unit can vary depending on the application. A single topographic unit can for instance have a surface area of 100-50 000 μm² or more, such as 500-25 000 μm², or 1 000-10 000 μm².

The topography of at least part of the units can for instance differ in surface porosity, surface roughness, and/or shape. An important aspect of this patent is that the surface features can be designed and the process for fabrication is well controlled so as to reproduce the designed topography. This is in contrast to patent US-A-2006/0 240 058, describing a method in which combinatorial chemistry rather than micro-fabrication is applied to create different surface roughnesses by blending of polymers. In this application, the geometry of the surface topology cannot be controlled. The surface porosity of the units can be varied in the range of 0-90%, such as 20-70%. The pores can have an average pore size of 50 μm or less, such as 1 nm-50 μm. The surface roughness may be varied in the range of 5-50 nanometers to a 5-10 μm. Also the hydrophobicity/hydrophilicity of at least part of the units can be varied. Furthermore, it is possible to provide at least part of the units with specific functional groups on the surface.

All or part of the units can comprise micrometer or nanometer scale features in one or more dimensions within the plane defined by the surface of the micro-array. The term “micrometer scale” as used herein is meant to refer to a length scale in the range of 1-1 000 μm. The term “nanometer scale” as used herein is meant to refer to a length scale in the range of 1-1 000 nm, in particular of 1-100 nm. The features can for example be structural features such as protrusions extending out of the surface of the micro-array. It is possible for the protrusions to have different cross-sectional geometry, such as round protrusions (e.g. circular or oval) and protrusions having a shape including corners such as polygons, triangles, rectangles, squares, hexagons, stars, parallelograms, etc. Further shapes of the topographical units can be found for instance in WO-A-2006/114098, which is herewith incorporated by reference. The topographical units of the micro-assay may be entirely artificial or may mimic a surface architecture observed in nature.

The features can have a lateral dimension in at least one lateral direction of 1-100 μm, such as in a range of 1-5 μm, 5-10 μm, 10-25 μm, 25-50 or 50-100 μm. Preferably, at least one lateral dimension is in the range of 1-10 μm. The shortest distance from any given point within the cross-sectional area of a feature to the edge of the cross-sectional area is preferably at most 20 μm, more preferably at most 10 μm, even more preferably at most 5 μm, e.g. at most 2 μm.

The maximum distance, or spacing, between any micrometer scale feature and its nearest neighbour can have a lateral dimension in at least one lateral direction of 1-50 μm, such as in a range of 1-5μm, 5-10 μm, 10-15 μm, 15-20 μm, 20-30μm, or 30-50μm. Preferably, the maximum distance between a feature and its nearest neighbour in lateral direction is preferably at most 30 μm, more preferably at most 10 μm, even more preferably at most 5 μm, e.g. at most 2 μm.

The depth/height of the features, i.e. their linear dimension in a direction projecting out of the surface of the micro-array can be on the nanometer or micrometer scale. Hence, the features may have heights/depths of at least 1 nm. The height/depths can be 50 μm, or even 100 μm. Accordingly, the features can have height/depths in a range of 1 nm-50 μm, such as in a range of 50-100 nm, 100-500 nm, 500-1 000 nm, 1-2μm, 2-5 μm, 5-10μm, 10-20 μm, 20-30 μm, 30-40 μm, or 40-50 μm. In some embodiments all features have substantially the same height, while in other embodiments the features may have different heights.

In the case where the environment comprises cells, it is possible to provide one or more cells on individual units and have the cells positioned on a relatively rough surface, but also to have cells positioned in a well of a specific shape, depending on the relative dimensions of the protrusions and/or surface roughness with respect to the cell dimensions. In the case of wells, it is important to keep the cells in the different wells and avoid that cells spread over the ridge of a well. This can for instance be controlled by coating the features with cell adhesive or repellent proteins and/or chemicals that force the cells within or on the anticipated shape. Such proteins and/or chemicals can be provided using stencil technology and/or microfluidics (see Dusseiller et al., Lab Chip 2005, 5(12), 1387-1392. In addition, the dimensions and/or the aspect ratio of the ridge of a well can also contribute to a control over the cell attachment.

The top and/or side surfaces of the features can be substantially flat, but it is also possible to have micrometer scale features with a surface that includes features on the nanometer scale. This allows for synergistic effects of the topography on the micrometer and the nanometer scale.

It is preferred that the multitude of units is regularly distributed over the micro-array. This can facilitate the contacting and screening of the multitude of units with the environment, for example the application of cells on the micro-array and the screening of the cells. However, a random distribution of the units over the micro-array is also possible.

The micro-array of the invention can be manufactured by methods known in the art.

An example of a method for manufacturing the micro-array is classical micro-fabrication, which combines photolithography and etching. Electron beam etching can be applied directly on metal (silicon) surfaces. These technologies allow the manufacture of highly complicated architectures on the micrometer scale. The choice of material is, however, limited, because the technique requires silicon or silicon-based materials making up the bulk. Optionally, a post-processing step, such as coating, can be performed in order to enhance the contact of these materials with the specific environment. The coating can for instance comprise proteins, silanes, carbons, collagen, biopolymers (such as heparin, hyaluronan), and the like. Other etching techniques which are less limited to the nature of the material are gas plasma etching, which can be applied on micropattern polymers, and (micro)stereolithography, which can be used as photopolymerisation process to directly fabricate a structured polymer.

Other examples of a method for manufacturing the micro-array are replication methods, such as hot embossing or soft lithography. These methods allow a broader range of materials than classical micro-fabrication. Hot embossing uses materials that can be processed from the melt, while soft lithography uses primarily elastomers such as poly(dimethyl)-siloxane (PDMS). In soft lithography a stamp is produced to create an ink micro-pattern on a scaffold surface. Subsequently, a coating is applied on the parts of the surface without ink. For precise patterning by soft lithography, rigid surfaces are preferred.

A simple method of preparing the micro-array is a membrane preparation method by casting. A solution is prepared by dissolving the material (polymer, ceramic, polymer/ceramic composite, or polymer blend, etc.) in a suitable solvent. The solution is cast on a structured surface/mould (which is usually prepared by traditional clean room technology) and left for solvent evaporation. A replica of the surface is therefore reproduced on the material, see e.g. M. Mulder, Basic principles of Membrane Technology, 2^{nd} ed., Dordrecht, The Netherlands, Kluwer academic publishers, 1996.

A micro-array which comprises a multitude of units at least part of which have different porosity (which can for example be interesting in the field of tissue engineering for nutrient diffusion to cells) can be manufactured using phase separation processes. Suitable phase separation processes for the manufacture of micro-arrays are described in WO-A-02/43937, which is herewith incorporated by reference.

Phase separation micro-moulding (PSμM) is a replication technology based on the phase separation process, which is mostly used in the fabrication of synthetic membranes. The process covers a very broad range of polymers. In PSμM, phase separation is combined with replication of structures on a micro- to sub-micrometer scale, see WO-A-02/43937. First a micro- to nano-structured master mould is prepared based on known technologies derived from microelectronics and photolithography. Thereafter, a desired polymer solution is casted onto the master. Phase separation can be induced, for example by immersing the casted polymer solution in a non-solvent for the polymer which is miscible with the solvent (liquid induced phase separation) or by a decrease of the temperature (thermally induced phase separation). Phase separation causes the casted polymer to solidify into the micro- to nano-sized three-dimensional architecture of the master mould. The polymeric microstructure can thereafter be released from the master mould. The polymer concentrations can for instance be 1-20 wt. %. Solvents used in this process can include N-methyl-2-pyrrolidone, dioxane, chloroform, acetone, toluene, alkanes, and benzenes. Non-solvents used in this process can include water, alcohols, alkanes, diethyl ether, etc. The decrease in temperature is typically a decrease of the temperature below the T_{c} of the polymer and can for instance be a decrease of 10° C. or more.

Depending on the composition of the polymer solution and the non-solvent, the resulting polymer film may exhibit an intrinsic porosity after phase separation, resulting in a porous micro-structured polymer. Moreover, this technology can be used to prepare topographic features not only onto polymeric, but also to inorganic materials (such as ceramics, metals or carbon) using post processing, such as pyrolysis or calcination. A possible way to achieve this is by taking a blend solution of polymer and ceramic and let it precipitate. Optionally, the polymer can be burnt out by a temperature treatment, sintering the ceramic at the same time.

It is possible to provide at least part of the topographic units with biologically active compounds such as peptides, proteins, sugars, antigens, antibodies, DNA, RNA, lipids, and/or growth hormones. The presence of one or more of such biologically active compounds and the interaction thereof with the environment (such as cells) can be exploited, for instance to steer a wound healing reaction by applying instructive properties to the materials. As an example, the Arg-Gly-Asp amino acid sequence is known to interact with the integrin family of adhesion receptors and coating of non-adhesive surfaces such as polyethylene glycol (PEG), with Arg-Gly-Asp peptides strongly improves binding and spreading of the cells. Alternatively, recombinant proteins involved in bone formation, such as BMP2 and IGF-1 are employed in controlled release strategies for tissue regeneration (see e.g. Chen et al. Growth Factors 2004, 22(4), 233-241 and Lutolf et al. Nat. Biotechnol. 2005, 23(1), 47-55).

In an embodiment the environment with which at least part of the multitude of units is contacted comprises cells. The cells can advantageously be stem cells (such as totipotent, pluripotent or multipotent stem cells), because these cells have the ability to self-replicate and give rise to specialised cells. However, also other types of cells can be applied. For cartilage and bone applications, mesenchymal stem cells are very suitable, because these cells can produce all cell types of bone and cartilage. The mesenchymal stem cells are preferably human. Human mesenchymal stem cells can be derived from bone-marrow. In a preferred embodiment cells are used. Contacting at least part of the multitude of units with the cells can be performed in vitro with single cells, but it is also possible for example to implant the micro-array in an organ culture in vitro, or even implant the micro-array in vivo. An example of the last possibility is a stent that is provided with a multitude of topographies that can be screened for endothelial attachment in vivo.

In view of variations occurring in a cell culture, it is recommended to screen a material and its topographies more than once with cells of the same culture, such as at least 10 times, preferably at least 100 times. In addition, as illustrated in the Examples below, each TopoUnit (feature set) can be repeated at least four times on each TopoChip.

According to a special embodiment of the invention, at least part of the multitude of topographical units on the micro-array are bone-forming cells, which can be any kind of cell that is capable of forming bone, including naturally occurring cell types and/or modified cell types, such as by means of genetic technologies.

A localised contact of the environment with at least part of the multitude of topographical units on the micro-array can be realised by means of microfluidics. This for instance allows positioning of cells on the micro-array. Depending on the array to be preformed, the number of cells per topological unit can be varied down to one cell per unit.

Furthermore, in case the environment comprises cells, it can be advantageous to apply a staining of the nucleus (for instance a Hoechst staining) or cytoskeleton (for instance a phalloidin staining) of the cells in order to determine the position and number of cells after deposition on the micro-array using microscopic techniques. These staining can show which units have one cell, which units have no cells, and which units have more than one cell.

Depending on the screening to be performed, the multitude of units are exposed to the environment for a certain period of time before screening the micro-array. For example, when cell attachments to the material are assessed a few hours of exposure before screening is sufficient, but when gene expression is analysed a longer period, such as one or two days, is desirable.

The interaction between one or more of the topographical units and the environment can comprise any measurable physical, chemical, and/or biological interaction. Examples of such interactions include chemical reactions, spectral shifts, hydrogen bonding, receptor-ligand interactions, electron transfer, energy transfer, adherence, electrostatical interactions, Van der Waals bonding, hydrophilic/hydrophobic interactions, dipole-dipole interactions, antigen-antibody binding, specific cellular behaviour (such as cell orientation, cell adhesion, cell proliferation, cell differentiation, and/or the expression of one or more proteins).

Specific cellular behaviour can for instance comprise differentiation of cells, such as a lineage-specific differentiation of cells, such as a differentiation specific for the osteogenic or chondrogenic lineage.

For detection purposes it can be advantageous that the interaction between one or more of the topographical units and the environment comprises light emission (such as fluorescence or phosphorescence), for example through the expression of one or more light emitting proteins. According to a preferred embodiment of the invention, the interaction comprises the expression of one or more fluorescent proteins that are under the control of one or more bone specific promoters (such as BSP, osteocalcin, collagen type I, and/or OSE1) and/or one or more cartilage specific promoters (such as collagen type 2, COMP, and collagen type X). The interaction can also comprise the expression of radio-labelled isotopes of specific proteins.

The interaction between one or more of the topographical units and the environment can be detected using suitable detection means. Examples include the detection of an optical signal such as produced by emitting proteins (for example green fluorescent protein and related proteins, firefly luciferase, Renilla luciferase and the like) or emitting antibodies. The optical signal can be detected for instance by using microscopy (such as fluorescent microscopy) including technology derived from it such as fluorescence lifetime imaging, and luminescent imaging using a charge coupled device camera.

According to a preferred embodiment of the invention, the interaction comprises the expression of one or more fluorescent proteins that are under the control of one or more regulatory DNA elements which represent a change in behaviour of cells. Examples include promoters of bone-specific genes such as BSP, osteocalcin, collagen type I, and/or OSE1) and/or one or more cartilage specific promoters (such as collagen type 2, COMP, and collagen type X).

In addition, the interaction between one or more of the topographical units and the environment can be monitored using immunohistochemistry using fluorescently or otherwise labelled antibodies. The interaction can also be monitored at the level of gene expression, for which several techniques can be applied such as in situ hybridisation, and polymerase chain reaction. Genomic changes can be visualised using fluorescent in situ hybridisation.

The parameter measuring the effect of the surface on its environment can use other optical imaging spectra. For instance, nuclear magnetic resonance (NMR) can be obtained from the environment, for which probes can be used such as quantum dots and other molecular entities used for NMR based imaging. Furthermore spectroscopic imaging can be applied to visualise the molecular make-up of the environment, such as Raman imaging and infrared spectroscopy. Light microscopy can be used to detect morphological features (for instance of cells or tissue grown on the surface). This can for instance yield cell biological information on items such as proliferation, apoptosis, attachment, etc.

Other methods for detection include atomic force microscopy, electron microscopy, scanning probe microscopy, scanning near field optical microscopy, X-ray photoelectron micrcoscopy, X-ray micro-analysis, X-ray diffraction, and/or surface Plasmon resonance.

In order to screen the micro-assay for the interaction between topographical units units and cells are applied, the cells can be genetically engineered with a fluorescent reporter. The fluorescent reporter can be introduced in the cells using lentiviral technology. For example, to detect osteo- or chondrogenic differentiation at the single cell level, hMSCs can be genetically engineered with a fluorescent reporter construct. To establish bone and cartilage-specific expression of the reporter, the fluorescent protein can be put under the control of promoters that are uniquely active in either bone or cartilage tissue but are not active in undifferentiated hMSCs. For the bone lineage a promoter can be selected from the group of bone specific promoters consisting of BSP osteocalcin, collagen type I, OSE1. For the cartilage lineage a promoter can be selected from the group of cartilage specific promoters consisting of collagen type 2, COMP, collagen type X. The fluorescent proteins can then be detected with for instance confocal laser scanning microscopy.

The result of the micro-array screening is a number of topographical units that can have different interactions with the environment. The features of these units can be produced on larges surfaces and the material/environment interaction can be analysed in greater detail using an array of molecular biological techniques, such as qPCR, reporter assays, biochemical assays etc.

In a further aspect the invention is directed to an apparatus for performing high throughput screening of the interaction between a surface of a material and an environment comprising:

a micro-array comprising said material and having a multitude of units at least part of which have different topography;

contacting means for contacting said micro-array with said environment; and

detection means for monitoring an interaction between one or more of said units and said environment.

### DESRIPTION OF THE FIGURES

FIG. 1: Illustration of the first design micro-array (TopoChip).

FIG. 2: Typical SEM pictures of moulds. (a), (b): mould with negative features, leading to pillars in polymer sheet. (c), (d): mold with positive features leading to pits in polymer sheet. Each field is 100×100 μm

FIG. 3: Typical SEM pictures of PLLA TopoChips with features. (a), (b): TopoChip with pits. (c), (d): TopoChip with pillars. (e), (f): cross-section of TopoChip with pits (e) and pillars (f). Each field is 100×100 μm. Note: TopoChip in FIG. 3b is inverse replication of mould in FIG. 2d. (g): Typical SEM picture of a topochips coated with Calcium Phosphate. (h): typical SEM picture of a Titanium sputtered topochip.

FIG. 4: Assembly of the cell seeding device.

FIG. 5: Modified seeding device with attachments for continuous flow.

FIG. 6: Uniform high density cell seeding with transgenic Chinese hamster ovarian cell line.

FIG. 7: Fluorescent microscopic image of low density (approximately 8-12 cells per TopoUnit) seeding of transgenic chinese hamster ovarian cell line.

FIG. 8: (a):TopoChip seeded with mouse embryonic stem cells stained with AlexaFluor 488 phalloidin imaged using Genepix pro 4200AL microarray scanner.

(b): Topochip seeded with Imortalised human mesenchymal stem cells stained with AlexaFluor 488 Phalloidin imaged with a BD Pathway 435.

(c): Typical picture of segmentation during computational automated cellular analysis.

FIG. 9: (a): Frequency of distribution of cells between TopoUnits (b)-(e): Random Light microscopic pictures of TopoChips immediately after cell seeding depicting uniform distribution of immortalized human mesenchymal stem cells

(f): Count of positive cells per TopoUnit.

The invention will now be illustrated by means of the following non-limiting examples.

### EXAMPLE 1

### Preparation of the Micro-Array (TopoChip)

The Topo-Chip was prepared by solvent casting a polymer solution on a micropatterned mould, resulting in a polymer sheet incorporating the inverse replication of the mould micropattern. Both Mouse ES cells as Transgenic Chinese Hamster Ovary Cells were cultured and analyzed with fluorescence microscopy.

### Mask Design and Mould Fabrication

To fabricate the micropatterned mould, silicon micromachining technologies were applied where, with the use of a projection mask, the micropattern is etched into a flat silicon wafer.

The projection mask design was drawn using the commercial available software CleWin layout editor version 4.0 (WieWeb Software, Hengelo, The Netherlands). The design was imported into a laser-system to write a chromium mask. This mask was used to project the pattern onto a photoresist layer present on a flat silicon wafer and after developing, the pattern was created in the photoresist.

The TopoChip mould was fabricated in two steps; first the walls of the TopoUnits were created through dry etching; second, the features were created through wet-chemical etching.

In a first design, a 2×2 cm chip was designed with fields of 100×100 μm (TopoUnits) that featured different patterns; the ridge-width between the TopoUnits was 10 μm.

The following pattern features were included:

Squares

Triangles

Circles

Octa gonals

5-pointed Stars

The dimensions of these features were systematically up-scaled in two ranges. The first range was within cell-size (1-20 μm) to increase surface roughness; the second range was exceeding cell-size (10-100 μm) to confine cells. The features to increase roughness included the following dimensions: 1, 2, 3, 5, 10, and 20 μm. The features to confine cells included the dimensions: 10, 20, 30, 40, 70, and 100 μm. All these dimensions were combined mutually within the specific range, leading to both symmetrical as asymmetrical features (i.e. square to rectangle, or circle to oval).

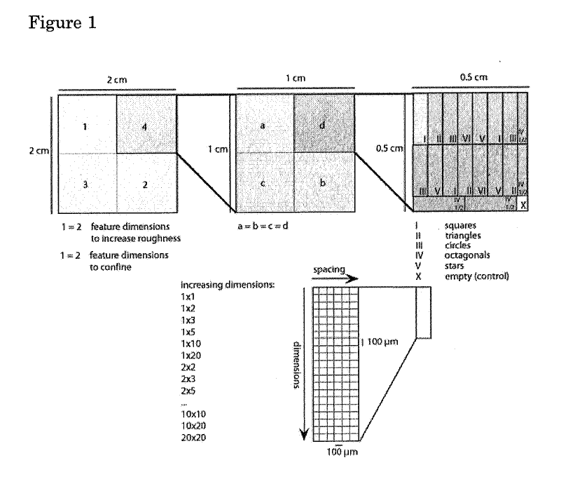

For the spacing between the features, the same values as for the feature dimensions were chosen and applied for all feature dimension combinations within that specific range. Each TopoUnit included features with only one parameter-set (feature type, dimension, and spacing); each parameter-set was repeated 12 or 13 times. See FIG. 1 for an illustration of this design. It has been found that symmetrical and/or random placement of topographic feature may have an influence on cell behaviour hence we have also developed an algorithm to design random patterns in each topounit.The information gathered from the screening of the TopoChips can be used as an input to develop more evolutionary algorithms for the generation of new designs for the chip.

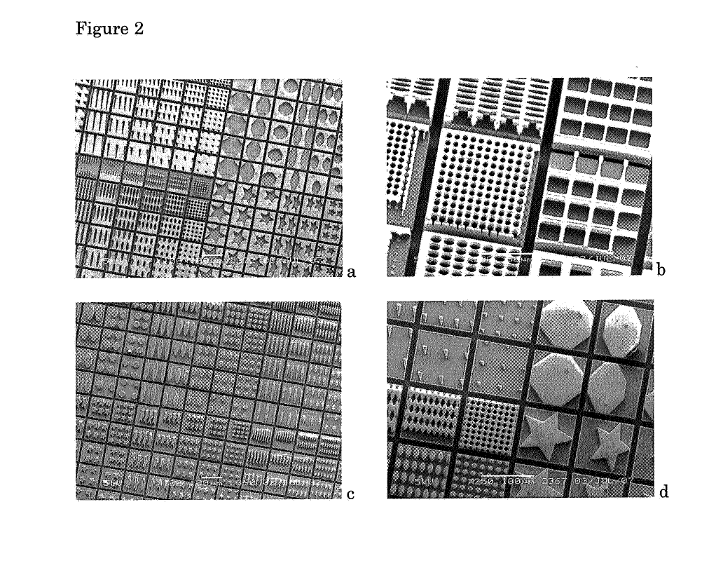

To obtain features both protruding (‘pillars’) as well as indentations (‘pits’), two moulds were fabricated using the same mask. To create the pillars (in the polymer chip), a negative photoresist was used where a positive photoresist was used to create the pits (in the polymer chip). See FIG. 2 for SEM pictures of the moulds.

To improve the TopoChip, a second design of the TopoChip was drawn. The second design included features of 3 μm and over. Besides taking into account the restrictions in the high resolution range, various new features were included, as well as variations on the already existing features. Furthermore, the etching process was adapted.

In the second design, again a 2×2 cm chip was designed. In this design, the TopoUnits were 90×90 μm; the ridge-width between the TopoUnits was kept at 10 μm, leading to a total number of 40 000 TopoUnits within one chip.

The following pattern features were included:

Squares

Triangles

Circles

Octagonals

5-pointed Stars

Hexagonals

3-pointed stars

Half moons

Circles with corner taken out (‘pacmans’)

Empty fields as control

Dimensions included within the range to increase roughness were: 3, 5, 7, 10, 15, and 20 μm. The features to confine cells included the dimensions: 20, 30, 40, 50, 65, and 80 μm. Again, all these dimensions were combined mutually within the specific range, leading to both symmetrical as asymmetrical features.

In case of the range to increase roughness, the same values as for the feature dimensions were chosen for the spacing between the features. For the range to confine cells, the following spacing values were included: 5, 10, 15, 20, 25, and 30 μm. Each spacing value was applied for every feature dimension combination within the specific range.

Furthermore, next to the ‘full’ features as described until now, of each feature type also a ‘hollow’ version was drawn; i.e. the feature incorporated a second similar feature inside which was 50% of the original to create a hollow space inside the feature.

In the second design, features in both positive (‘pillars’) as well as in negative (‘pits’) were drawn within one design by inverse of the pattern, enabling to create one mould with both types of features.

Each TopoUnit included features with only one parameter-set (feature type, dimension, and spacing, full or hollow feature, pillar or pit); each parameter-set was repeated 4 times.

### TopoChip Fabrication

Poly(L-lactic acid) (PLLA) (Mw: 267 000 gmol⁻¹) was dissolved in chloroform (Merck, analytical quality) to obtain a 10 wt. % solution. The solution was cast onto the micropatterned mould at various initial casting thicknesses (dᵢ) of 250-1 000 μm. In favour of the processability, dᵢ of 500 μm was chosen, with resulting final thicknesses (d_{f}) of about 50/80 μm (without features/with features), as standard and results presented are of sheets with this thickness unless stated differently.

The solvent was evaporated leading to solidification of the polymer. The resulting dense polymer sheet incorporating the inverse replication of the mould micropattern could be released from the mould after wetting in Milli-Q water for at least 1 hour. Subsequently, the sheet was thoroughly washed in Milli-Q water for minimal 1 day and dried in a controlled atmosphere (T=19-20° C.).

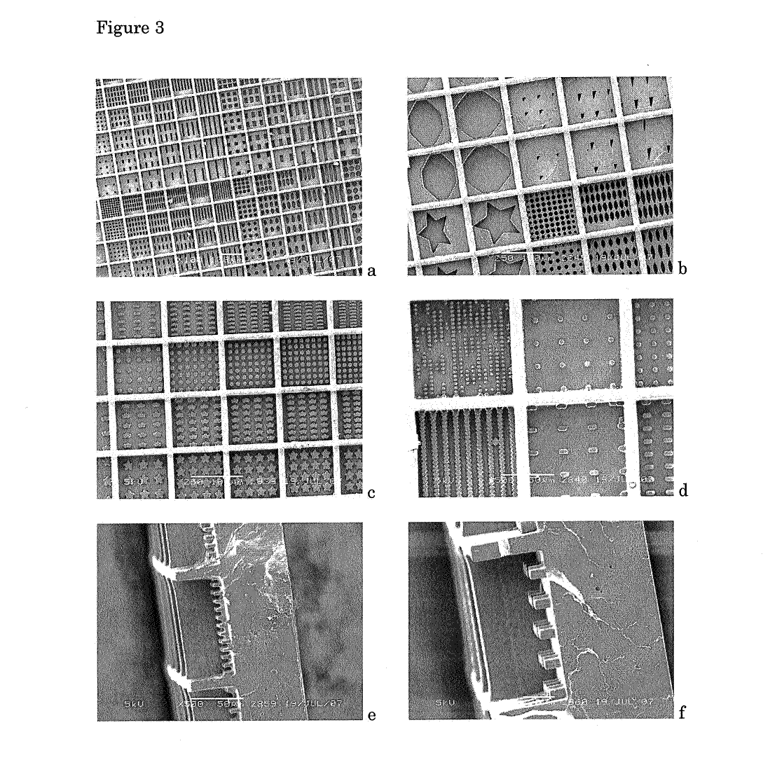

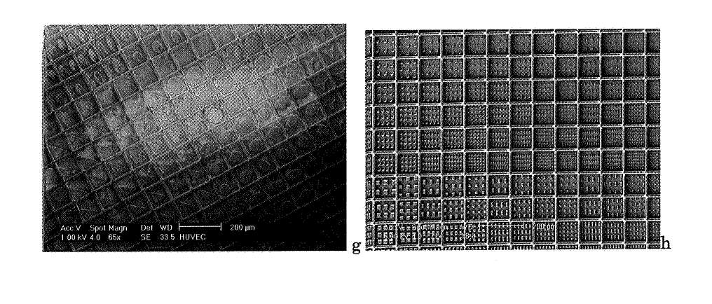

The solvent casting and evaporation lead to successful fabrication of the TopoChips. High replication quality of the features was observed for PLLA. See FIG. 3 for SEM pictures of the polymer TopoChip. No TopoChips were yet fabricated with moulds incorporating the second TopoChip design.

### Cell Seeding of the TopoChip

### Mouse ES Cell Culture

Mouse embryonic stem cell line IB10 was cultured as described by Smith et al. in Dev. Biol. 1987, 121(1), 1-9. In brief, cells were plated at a density of 5 000-10 000 cells/cm2 on gelatine-coated tissue culture flasks. Mouse ES cells were cultured in 50% mES proliferation medium consisting of Dulbecco's Modified Eagle's Medium (DMEM, Biowhittaker) containing 4.5 mg/ml D-glucose, 10% foetal bovine serum (selected batch for mES cell culture, Greiner), 0.1 mM non-essential amino acids (NEAA, Sigma), 4 mM L-glutamine (Invitrogen), 100 U/ml penicillin (Invitrogen), 100 μg/m1 streptomycin (Invitrogen) and 50% of Buffalo rat liver cell-conditioned mES proliferation medium. Prior to use 1 000 U/ml Leukemia Inhibitory Factor (Esgro, Chemicon International) and 50 μM 2-mercapto-ethanol (Gibco) were added to the medium. Cells were grown at 37° C. in a humidified 5% CO₂ incubator and passaged with 0.05% trypsin/EDTA before reaching confluence.

640 000 cells were seeded onto a 2×2 cm topochip which were placed in a two chamber slide (Lab-tek chamber slide, Nalge Nunc International). The chips were secured using Viton 75, Compound 51414 gaskets (Eriks NL) inside the chamber slide.

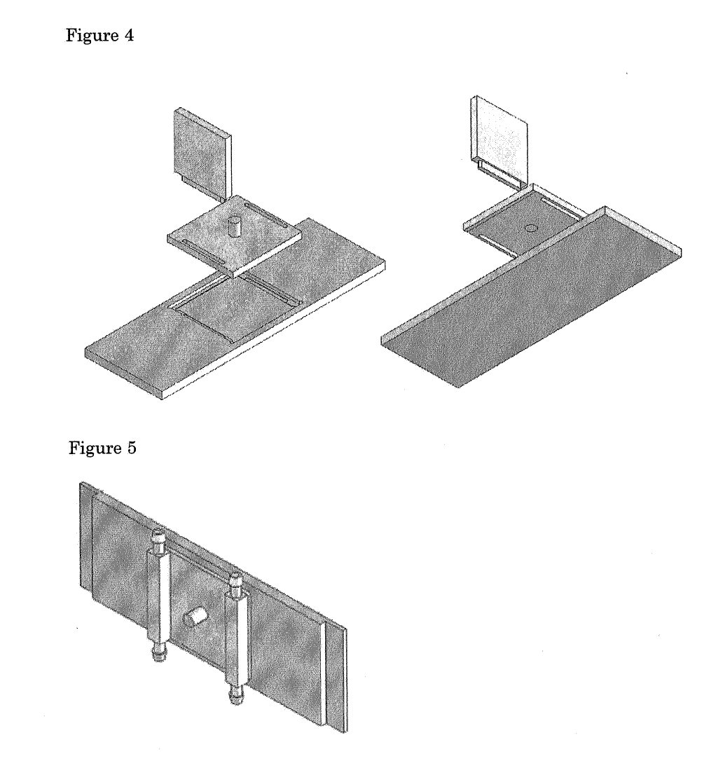

In order to achieve uniformity of cell seeding, a seeding device was fabricated with the technology described by Park et al. Lab Chip 2006, 6(8), 988-994. The device was fabricated by micromachining of polymethyl methacrylate. The seeding device includes a 0.1 mm ditch for the placement of the TopoChip. It also includes an inlet and outlet reservoirs, see FIG. 4.

For maintaining the nutrition of the cells a continuous laminar flow of medium can be achieved by modifying the seeding device by including an inlet and outlet (as shown in FIG. 5) for the flow of the medium by using a flow rate of 140 μl/min.

### Transgenic Chinese Hamster Ovary Cells

Chinese hamster ovary cells expressing GFP under control of constitutively active promoter CMV were used in order to test for the microarray scanner based imaging. The cells were cultured in a tissue culture flask using DMEM, 10% FBS and 100 Ural penicillin (Invitrogen), 100 μg/ml streptomycin (Invitrogen).

Various concentrations of the cells were seeded on the Topochip using the seeding device and the chip was imaged 1 hour after seeding using a fluorescent microscope to check for uniformity of seeding.

### Mouse ES Cell Culture and Transgenic Chinese Hamster Ovary Cells

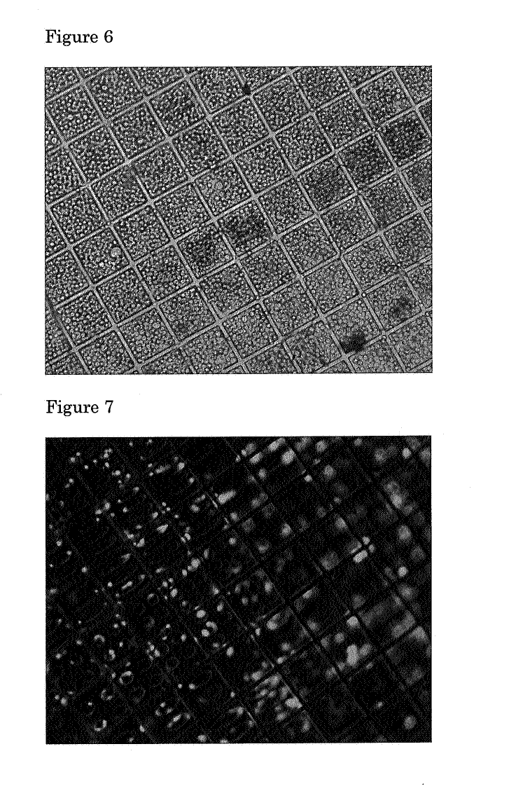

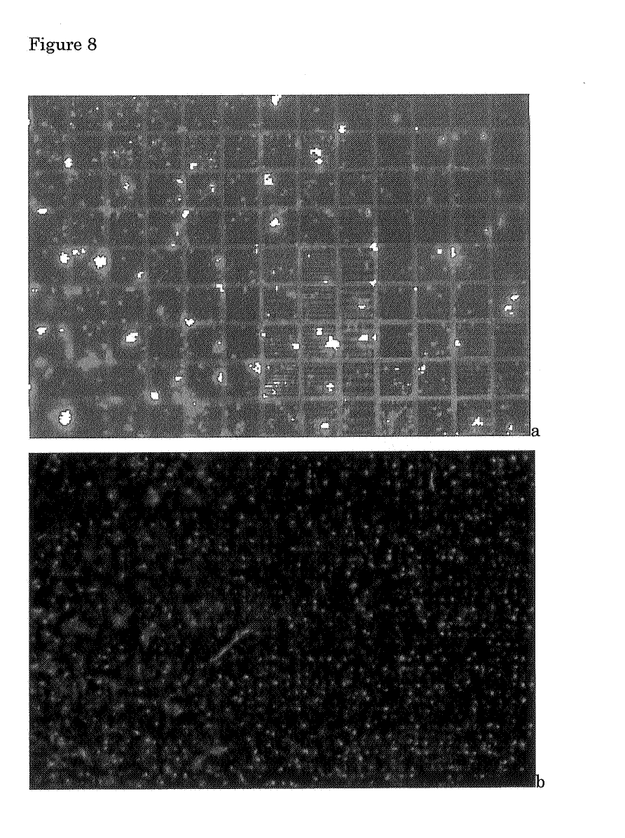

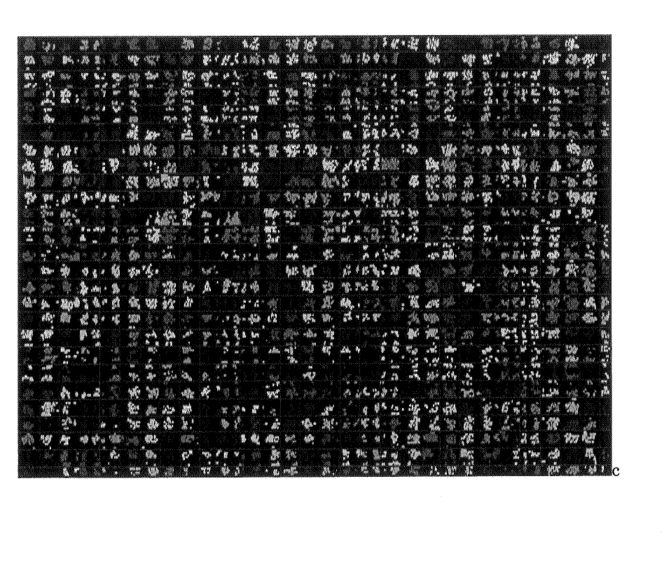

FIGS. 6 and 7 shows that a uniform cell seeding density in the TopoUnits is achieved using this technique. FIG. 8 demonstrates that it is possible to carry out high-throughput screening of the TopoChip by fluorescence assays using a microarray scanner. Experiments with mouse embryonic stem cells show that these cells respond to changes in the shape of cytoskeleton to systematic and ordered variations in surface features.

### EXAMPLE 2

### Fabrication of TopoChips

The topographies were created on a 2cm×2cm area of silicon master using photolithography and etching. The design consisted of around 8000 variations in surface topographies distributed in a 90 μm×90 μm square area called as a Topounit. Each Topounit was repeated 4 times and finally 40,000 topounits constituted a TopoChip by filling the rest with blank Topounits. Hot embossing was performed using an Obducat Hot embossing/Nano Imprint tool (Obducat AB, Sweden). Polymer micropatterned chips were produced by loading the PLA sheet into the imprinting system wherein it covered the silicon master. The imprinting proceeded upon closing the chamber so that the press was in contact with both the master and the underlying piece of master material. The master-polymer-substrate sandwich was heated to 80° C., 20° C. above the Tg of the PLA (60° C.), before an imprinting force of 3-MPa pressure was applied. After a predetermined embossing time of 600 sec, the temperature was reduced to 38° C., below that of Tg, while maintaining the applied force. On reaching this temperature, the pressure was released. The polymer was then allowed to slowly cool to room temperature before the master was manually separated from the polymer.

### Cell Culture

An immortalised human mesenchymal stem cell line was used for cell culture experiments. The cells were cultured in medium consisting of minimal essential medium (aMEM Life Technologies), 10% FBS (Cambrex), 2mM L-glutamine (Life Technologies), 100 units/m.1 penicillin (Life Technologies) and 10 μg/ml streptomycin (Life Technologies). Cells were grown at 37° C. in a humidified 5% CO₂ incubator and passaged with 0.05% trypsin/EDTA before reaching confluence. 24 hrs prior to using the cells for seeding on the TopoChips the medium in the flask was replaced with a medium devoid of FBS to starve the cells and to synchronise the cell cycle in the G0 phase.

1.8×10⁶ were seeded onto a 2 cm×2 cm topochip which was placed in a custom made PMMA seeding device and the lid was closed, thus resulting in equal distribution of cells throughout the surface of the chip. The cells were allowed to settle down and attach for 2 hrs following which the seeding device was subjected to continuous perfusion of medium at a rate of 100 μl/min using a peristaltic pump.

### Immunostaining

Following 8 hrs of culture, the cells were washed with PBS and fixed with 4 wt % paraformaldehyde for 15 rains at room temperature. The cells were then washed again with PBS and permaeablised with 0.01% Triton-X 100 solution for 4 mins. The samples were again rinsed with PBS and blocked with 3% bovine serum albumin for 30 rains. The samples were then incubated with 1:200 diluted primary antibody against human Ki-67 (sc-15402 SantaCruz Biotechnology, Inc.) for 2 hrs in a humidified chamber. The samples were washed and subsequently incubated with 1:1000 secondary goat anti rabbit Alexa 488 (Molecular Probes) conjugated antibody for 1 hr in a dark humidified chamber. The samples were again washed and stained with 1:40 Alexa 568 Phalloidin (Molecular Probes) and 1 μg/ml DAPI for 20 minutes.

### Imaging

Imaging of the samples was performed using a confocal high content screening system (BD Pathway 435). In short a montage of images of the whole chip was made by creating a macro with 3 probe cycles.

### Image Analysis

Image analysis was done using CellProfiler software. In short the montage images obtained after imaging were converted to .png format. The images were then run through a custom pipeline which included the griding algorithm to identify the TopoUnits. Subsequently the DAPI and Alexa 488 images were used to quantify the cell numbers and number. of proliferating cell per Topounit.

### Results

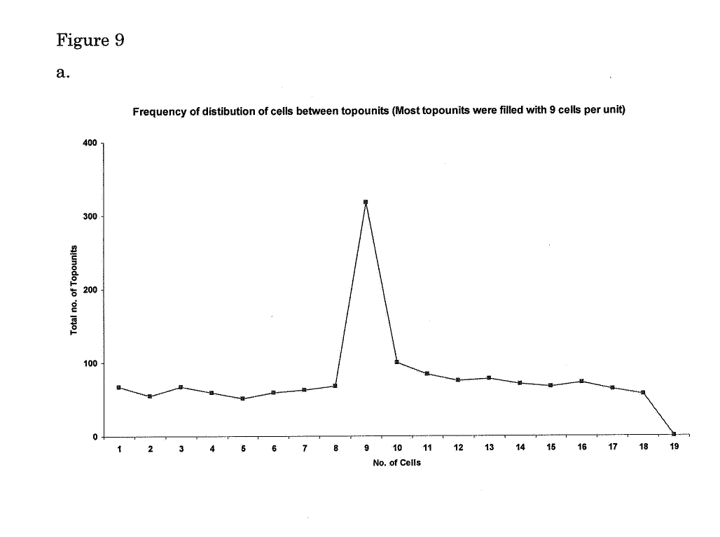

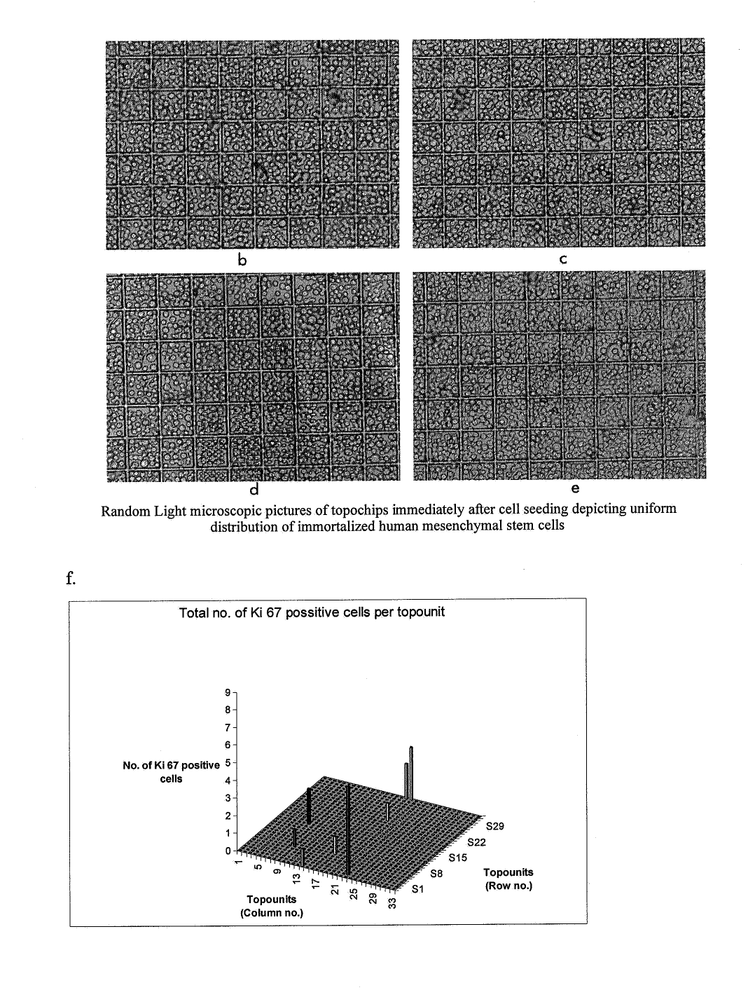

The TopoChips produced by hot embossing possessed well defined surface topographies consistent over numerous replications. In addition, the precise array of distinct topographically patterned fields allowed us to perform automated high througput analysis of cell behavior. We were able to distribute the cells uniformly across the topounits. FIG. 9a. shows the frequency of cell distribution between the Topounits. In brief more than 80% of the Topounits were filled with 6 to 14 cells. Furthermore we analysed the images for Ki-67 antibody staining and we were able to quantify the no. of Ki-67 possitive cell per topounit over an area of 1467 topounits. These results illustrate the potency and the viability of the technique.

1. High throughput screening method for analysing analyzing an interaction between a surface of a material and an environment comprising:
providing a micro-array comprising said material and having a multitude of units at least part of which have different topography;
contacting at least part of said multitude of units with said environment; and
screening said micro-array for an interaction between one or more of said units and said environment.

2. High throughput screening method according to claim 1, wherein said environment comprises one or more selected from the group consisting of a tissue, a cell, a complex molecular mixture and specific molecules.

3. High throughput screening method according to claim 1, wherein said interaction comprises one or more selected from the group consisting of a chemical reaction, spectral shift, hydrogen bonding, receptor-ligand interaction, electron transfer, energy transfer, adherence, electrostatical interaction, Van der Waals bonding, hydrophilic/hydrophobic interaction, dipole-dipole interaction, antigen-antibody binding, and/or specific cellular behavior.

4. High throughput screening method according to claim 2 3, wherein said specific cellular behavior comprises one or more selected from the group consisting of cell orientation, cell adhesion, cell proliferation, cell differentiation, and the expression of one or more proteins.

5. High throughput screening method according to claim 1, wherein said material is a biodegradable and/or biocompatible material.

6. High throughput screening method according to claim 1, wherein said material is selected from the group consisting of polyethylene oxide/polybutylene terephthalate copolymers, polymers of the polyester family and their copolymers, polylactones, polycarbonates, polyanhydrides, polyorthoesters, polyurethanes, and copolymers and/or blends thereof

7. High throughput screening method according to claim 1, wherein said material is chosen selected from the group consisting of ceramics, metals, polymer/ceramic composites, carbon, and blends and/or composites thereof.

8. High throughput screening method according to claim 1, wherein said micro-array comprises at least 100 topographic units.

9. High throughput screening method according to claim 8, wherein the surface area of the single topographic units in the micro-array is in the range of 100-50000 μm².

10. High throughput screening method according to claim 1, wherein the multitude of units comprise structural features comprising a dimension perpendicular to the microarray surface in the range of 1 nm to 100 μm.

11. High throughput screening method according to claim 1, wherein the topography of at least part of said units differ in surface porosity, surface roughness, hydrophobicity, and/or shape.

12. High throughput screening method according to claim 1, wherein at least part of said units comprises one or more biologically active compounds selected from the group consisting of proteins, sugars, antigens, antibodies, DNA, RNA, lipids, and/or growth hormones.

13. High throughput screening method according to claim 1, wherein said environment comprises stem cells.

14. High throughput screening method according to claim 1, wherein said interaction comprises a lineage specific differentiation of cells comprised in said environment.

15. High throughput screening method according to claim 14, wherein said differentiation is specific for the osteogenic or chondrogenic lineage.

16. High throughput screening method according to claim 1, wherein said interaction comprises the expression of one or more fluorescent proteins.

17. High throughput screening method according to claim 16, wherein said one or more fluorescent proteins are under the control of one or more bone-specific promoters and/or one or more cartilage-specific promoters.

18. High throughput screening method according to claim 17, wherein said one or more bone-specific promoters are selected from the group consisting of BSP, osteocalcin, collagen type I, and OSE1.

19. High throughput screening method according to claim 17, wherein said one or more cartilage-specific promoters are selected from the group consisting of collagen type 2, COMP, and collagen type X.

20. High throughput screening method according to claim 1, wherein said screening comprises one or more selected from the group consisting of microscopy derived from a technology selected from the group consisting of such as fluorescence lifetime imaging, luminescent imaging, immunohistochemistry, in situ hybridisation, polymerase chain reaction, fluorescent in situ hybridisation, nuclear magnetic resonance, Raman imaging, infrared spectroscopy, atomic force microscopy, electron microscopy, scanning probe microscopy, scanning near field optical microscopy, X-ray photoelectron micrcoscopy, X-ray micro analysis, X-ray diffraction, and surface Plasmon resonance.

21. Apparatus for performing high throughput screening of the interaction between a surface of a material and an environment comprising:
a micro-array comprising said material and a multitude of units at least part of which have different topography;
a contacting component for contacting said micro-array with said environment; and
a detection component for monitoring an interaction between one or more of said units and said environment.

22. High throughput screening method according to claim 1, wherein said environment comprises one or more selected from the group consisting of body fluid, soil, sea water, air, cell lysates, organs or whole organisms, waste products, urine, and faeces.

23. High throughput screening method according to claim 1, wherein said micro-array comprises at least 10000 topographic units.

24. High throughput screening method according to claim 1, wherein said micro-array comprises at least 30000 units.

25. High throughput screening method according to claim 1, wherein said micro-array comprises 40000-300000 units.

26. High throughput screening method according to claim 8, wherein the surface area of the single topographic units in the micro-array is in the range of 500-25000 μm².

27. High throughput screening method according to claim 8, wherein the surface area of the single topographic units in the micro-array is in the range of 1000-10000 μm².

28. High throughput screening method according to claim 1, wherein the multitude of units comprise structural features comprising a dimension perpendicular to the microarray surface in the range of 50 nm to 50 μm.

29. High throughput screening method according to claim 1, wherein said environment comprises mesenchymal stem cells.

30. High throughput screening method according to claim 1, wherein said environment comprises human mesenchymal stem cells.
